(19) United States
(12) Patent Application Publication
(10) Pub. No.: US 2022/0152976 A1
(43) Pub. Date: May 19, 2022

(54) KNITTED TEXTILE

(71) Applicant: JHIH HUEI TRADING CO., LTD., Changhua County (TW)

(72) Inventor: YUNG-YU WU, Changhua County (TW)

(21) Appl. No.: 17/591,948

(22) Filed: Feb. 3, 2022

Related U.S. Application Data
(63) Continuation-in-part of application No. 16/809,054, filed on Mar. 4, 2020.

(51) Int. Cl. B32B 5/26; D04B 21/10; B32B 5/02; B32B 5/06

(52) U.S. Cl. CPC B32B 5/26; D04B 21/10; B32B 5/06; B32B 5/028; B32B 5/026

(57) ABSTRACT

A knitted textile is provided, including: a main body, knitted by threads, defining a first end and a second end along a lateral direction and defining an upper end and a lower end along a longitudinal direction, each thread extending continuously from the upper end toward the lower end, each thread extending toward the first end and toward the second end alternately to form first loops and second loops arranged zigzag, the first loops being closer to the first end and more remote from the second end than the second loops, each first loops being disposed through a lower one of the second loops adjacent thereto and connected to an upper one of the second loops adjacent thereto, each second loops being disposed through a lower one of the first loops adjacent thereto and connected to an upper one of the first loops.

### BACKGROUND OF THE INVENTION

### Field of the Invention

The present invention is a CIP of application Ser. No. 16/809,054, filed Mar. 4, 2020, the entire contents of which are hereby incorporated by reference.

### Description of the Prior Art

In the conventional knitted textile, if a larger mesh is to be produced, it is often knitted in a manner such as that disclosed in TW I656253. That is, each row of the weaving threads extends in a wavy shape, and the adjacent weaving threads correspond to each other with wave crests and valleys. The crests of one of the weaving threads are nested at two said valleys at the root portion of the crest of adjacent one of the weaving threads, thereby making the weaving threads nest with each other.

However, this kind of structure is an extremely unstable weaving configuration. Since each weaving thread only extends in a wavy shape without any knot or fixation structure, when the weaving thread is pulled by an external force, the entire weaving thread is dislocated so that the woven textile is badly deformed. In addition, this type of knitted textile is overflexible, which causes the problem of easy deformation due to the external force.

The present invention is, therefore, arisen to obviate or at least mitigate the above-mentioned disadvantages.

### SUMMARY OF THE INVENTION

The main object of the present invention is to provide a knitted textile which is provided with a stable woven configuration with meshes having considerable size.

To achieve the above and other objects, the present invention provides a knitted textile, including a main body, the main body being knitted by a plurality of threads and defining a lateral direction and a longitudinal direction, two ends of the main body along the lateral direction being defined as a first end and a second end, two ends of the main body along the longitudinal direction being defined as an upper end and a lower end, each of the plurality of threads extending continuously from the upper end toward the lower end, during extending from the upper end toward the lower end, each of the plurality of threads extending toward the first end and toward the second end alternately to form a plurality of first loops and a plurality of second loops arranged zigzag, the plurality of first loops being closer to the first end and more remote from the second end than the plurality of second loops, each of the plurality of first loops being disposed through a lower one of the plurality of second loops adjacent thereto and connected to an upper one of the plurality of second loops adjacent thereto, each of the plurality of second loops being disposed through a lower one of the plurality of first loops adjacent thereto and connected to an upper one of the plurality of first loops.

The present invention will become more obvious from the following description when taken in connection with the accompanying drawings, which show, for purpose of illustrations only, the preferred embodiment(s) in accordance with the present invention.

### BRIEF DESCRIPTION OF THE DRAWINGS

FIG. 1 is a stereogram of a knitted textile according to a preferable embodiment of the present invention;

FIG. 2 is a stereogram of a first knitted layer of the knitted textile according to a preferable embodiment of the present invention; and

FIG. 3 is a stereogram of a second knitted layer of the knitted textile according to a preferable embodiment of the present invention.

### DETAILED DESCRIPTION OF THE PREFERRED EMBODIMENTS

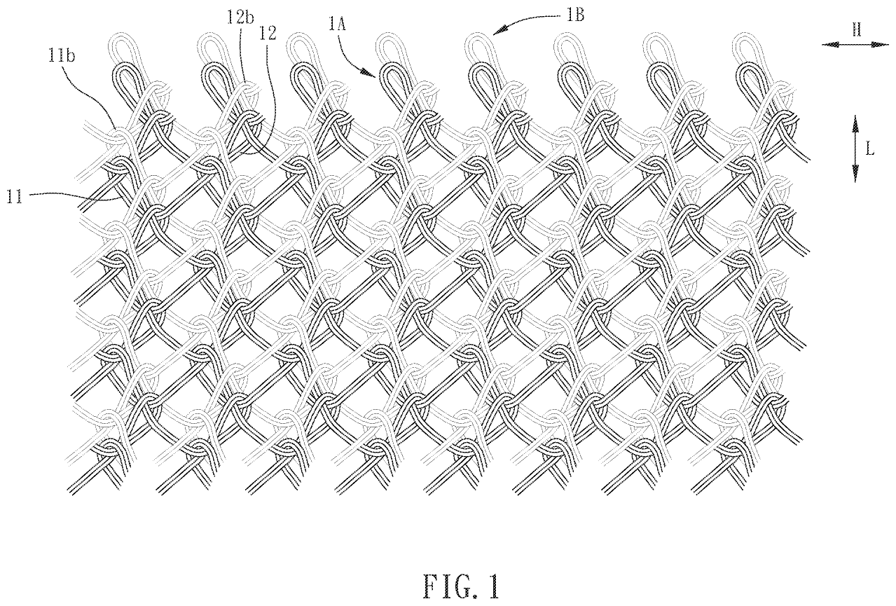

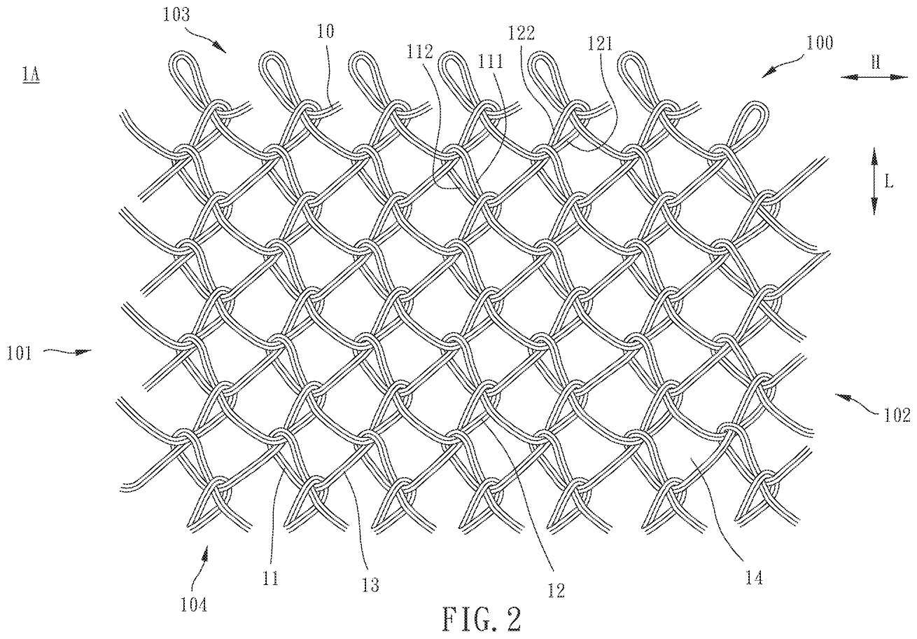

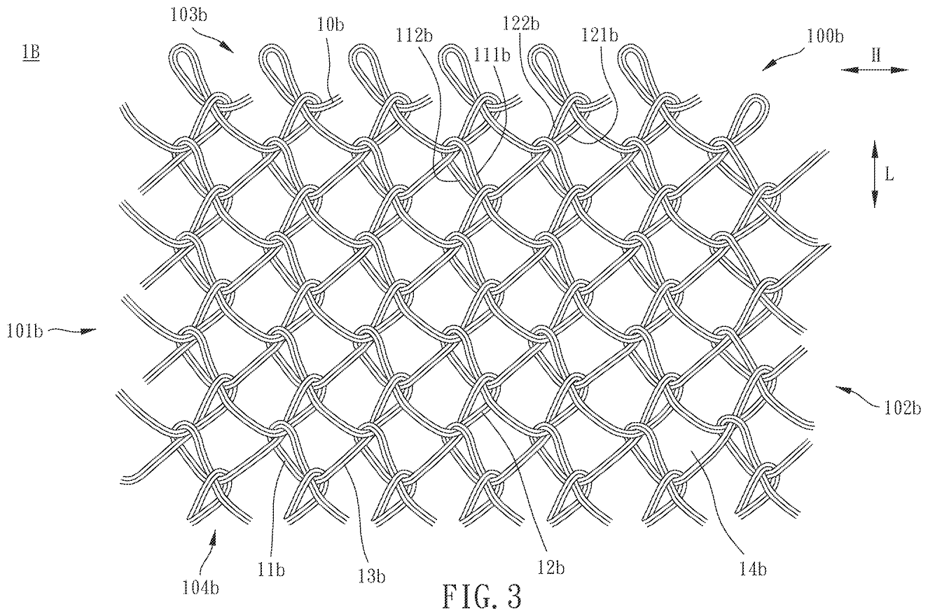

Please refer to FIGS. 1 to 3 for a preferable embodiment of the present invention. A knitted textile of the present invention is provided. The knitted textile comprises a first knitted layer 1A and a second knitted layer 1B. The first knitted layer 1A comprises a main body 100. The main body 100 is knitted by a plurality of threads 10 (in this embodiment, each of the plurality of threads 10 is a multifilament thread; however, each of the plurality of threads may be a monofilament thread) and defines a lateral direction H and a longitudinal direction L which are perpendicular to each other. Two ends of the main body 100 along the lateral direction H is defined as a first end 101 and a second end 102, and two ends of the main body 100 along the longitudinal direction L is defined as an upper end 103 and a lower end 104. Each of the plurality of threads 10 extends continuously from the upper end 103 toward the lower end 104 (it is noted that “upper” and “lower” are relative terms in the invention the terms and should not be limited to absolute positions in a vertical direction). During extending from the upper end 103 toward the lower end 104, each of the plurality of threads 10 extends toward the first end 101 and toward the second end 102, alternately in the longitudinal direction L, to form a plurality of first loops 11 and a plurality of second loops 12 arranged zigzag. The plurality of first loops 11 are closer to the first end 101 and more remote from the second end 102 than the plurality of second loops 12. Each of the plurality of first loops 11 is disposed through a lower one of the plurality of second loops 12 adjacent thereto and connected to an upper one of the plurality of the second loops 12 (relatively closer to the upper end 103). Each of the plurality of second loops 12 is disposed through a lower one of the plurality of first loops 11 adjacent thereto and connected to an upper one of the plurality of the first loops 11 adjacent thereto (relatively closer to the upper end 103).

Specifically, each of the plurality of first loops 11 is configured by one of the plurality of threads 10 first extending toward the upper end 103 and toward the first end 101 (upper left) and then bending to extend toward the lower end 104 and toward the second end 102 (lower right), and each of the plurality of second loops 12 is configured by one of the plurality of threads 10 first extending toward the upper end 103 and toward the second end 102 (upper right) and then bending to extend toward the lower end 104 and toward the first end 101 (lower left), wherein the plurality of first loops 11 and the plurality of second loops 12 of the same one of said thread 10 are located at two opposite sides by the longitudinal direction L.

The plurality of the first loops 11 of each of the plurality of threads 10 are arranged in line along the lateral direction H, and the plurality of the second loops 12 each of the plurality of threads 10 are arranged in line along the lateral direction H. In other words, the plurality of the first loops 11 are arranged in a plurality of first rows located on different levels, and the plurality of the second loops 12 are arranged in a plurality of second rows located on different levels, wherein the plurality of first rows and the plurality of second rows are alternatively arranged from the upper end 103 toward the lower end 104.

Specifically, each of the plurality of threads 10 further includes a plurality of extension sections 13 each connected between one said first loop 11 and one said second loop 12. Preferably, each of the plurality of extension sections 13 is tilted relative to the lateral direction H at an angle of 45 degrees. In the lateral direction H, extents of each of the plurality of extension sections 13, each of the plurality of first loops 11 and each of the plurality of second loops 12 are substantially the same. Similarly, in the longitudinal direction L, extents of each of the plurality of extension sections 13, each of the plurality of first loops 11 and each of the plurality of second loops 12 are substantially the same, so that the plurality of threads 10 further define a plurality of meshes 14 each being substantially diamond.

Preferably, two halves of each of the plurality of first loops 11 cross and interlace with each other within one said second loop 12, and two halves of each of the plurality of second loops 12 cross and interlace with each other within one said first loop 11. Specifically, one of the two halves of each of the plurality of first loops 11 which bends to extend toward the lower end 104 and toward the second end 102 is located between the other of the two halves of each of the plurality of first loops 11 and an upper portion of one said second loop 12; and one of the two halves of each of the plurality of second loops 12 which bends to extend toward the lower end and toward the first end 101 is located between the other of the two halves of each of the plurality of second loops 12 and a lower portion of one said first loop 11.

Each loop of the plurality of first loops 11 of the first thread comprises a first upper section 111 and a first lower section 112 which are connected and crossed, and each loop of the plurality of second loops 12 of the second thread comprises a first extension strip 121 and a second extension strip 122 which are connected and crossed.

The first upper section 111 extends toward the upper end 103 and toward the first end 101, and is crossed above the first lower section 112. The first extension strip 121 extends toward the upper end 103 and toward the second end 102, and is crossed above the second extension strip 122.

The first upper section 111 is disposed through the lower one of the plurality of second loops 12 of the second thread, and extends above the first extension strip 121 of the upper one of the plurality of second loops 12 of the second thread.

The first lower section 112 extends under the second extension strip 122 of the upper one of the plurality of second loops 12 of the second thread, extends toward the lower end 104 and toward the second end 102, and is disposed through the lower one of the plurality of second loops 12 of the second thread.

The first extension strip 121 is disposed through the lower one of the plurality of first loops 11 of the first thread, and extends under the first lower section 112 of the upper one of the plurality of first loops 11 of the first thread.

The second extension strip 122 extends above the first upper section 111 of the upper one of the plurality of first loops 11 of the first thread, extends toward the lower 104 end and toward the first end 101, and is disposed through the lower one of the plurality of first loops 11 of the first thread.

The second knitted layer 1B comprises a main body 100b, the main body 100b of the second knitted layer 1B is knitted by a plurality of threads 10b, two ends of the main body 100b of the second knitted layer 1B along the lateral direction H are defined as a first end 101b and a second end 102b, and two ends of the main body 100b of the second knitted layer 1B along the longitudinal direction L are defined as an upper end 103a and a lower end 104b. Each thread of the plurality of threads 10b of the second knitted layer 1B extends continuously from the upper end 103a of the main body 100b of the second knitted layer 1B toward the lower end 104b of the main body 100b of the second knitted layer 1B, wherein during extending from the upper end 103a of the main body 100b of the second knitted layer 1B toward the lower end 104b of the main body 100b of the second knitted layer 1B, each thread of the plurality of threads 10b of the main body 100b of the second knitted layer 1B extends toward the first end 101b of the main body 100b of the second knitted layer 1B and toward the second end 102b of the main body 100b of the second knitted layer 1B alternately to form a plurality of first loops 11b and a plurality of second loops 12b arranged zigzag. Each loop of the plurality of first loops 11b of a first thread of neighboring two of the plurality of threads 10b of the second knitted layer 1B is disposed through a lower one of the plurality of second loops 12b of a second thread of the neighboring two of the plurality of threads 10b of the second knitted layer 1B and disposed around an upper one of the plurality of second loops 12b of the second thread of the second knitted layer 1B, the second thread of the second knitted layer 1B is next to the first thread of the second knitted layer 1B, and each loop of the plurality of second loops 12b of the second thread of the second knitted layer 1B is disposed through a lower one of the plurality of first loops 11b of the first thread of the second knitted layer 1B and disposed around an upper one of the plurality of first loops 11b of the first thread of the second knitted layer 1B.

Each loop of the plurality of first loops 11b of the first thread of the second knitted layer 1B comprises a first upper section 111b and a first lower section 112b which are connected and crossed, and each loop of the plurality of second loops 12b of the second thread of the second knitted layer 1B comprises a first extension strip 121b and a second extension strip 122b which are connected and crossed. The first upper section 111b of each loop of the plurality of first loops 11b of the first thread of the second knitted layer 1B extends toward the upper end 103a of the main body 100b of the second knitted layer 1B and toward the first end 101b of the main body 100b of the second knitted layer 1B, and is crossed above the first lower section 112b of each loop of the plurality of first loops 11b of the first thread of the second knitted layer 1B. The first extension strip 121b of each loop of the plurality of second loops 12b of the second thread of the second knitted layer 1B extends toward the upper end 103a of the main body 100b of the second knitted layer 1B and toward the second end 102b of the main body 100b of the second knitted layer 1B, and is crossed above the second extension strip 122b of each loop of the plurality of second loops 12b of the second thread of the second knitted layer 1B.

The first upper section 111b of each loop of the plurality of first loops 11b of the first thread of the second knitted layer 1B is disposed through the lower one of the plurality of second loops 12b of the second thread of the second knitted layer 1B, and extends above the first extension strip 121b of the upper one of the plurality of second loops 12b of the second thread of the second knitted layer 1B.

The first lower section 112b of each loop of the plurality of first loops 11b of the first thread of the second knitted layer 1B extends under the second extension strip 122b of the upper one of the plurality of second loops 12b of the second thread of the second knitted layer 1B, extends toward the lower end 104b of the main body 100b of the second knitted layer 1B and toward the second end 102b of the main body 100b of the second knitted layer 1B, and is disposed through the lower one of the plurality of second loops 12b of the second thread of the second knitted layer 1B.

The first extension strip 121b of each loop of the plurality of second loops 12b of the second thread of the second knitted layer 1B is disposed through the lower one of the plurality of first loops 11b of the first thread of the second knitted layer 1B, and extends under the first lower section 112b of the upper one of the plurality of first loops 11b of the first thread of the second knitted layer 1B.

The second extension strip 122b of each loop of the plurality of second loops 12b of the second thread of the second knitted layer 1B extends above the first upper section 111b of the upper one of the plurality of first loops 11b of the first thread of the second knitted layer 1B, extends toward the lower end 104b of the main body 100b of the second knitted layer 1B and toward the first end 101b of the main body 100b of the second knitted layer 1B, and is disposed through the lower one of the plurality of first loops 11b of the first thread of the second knitted layer 1B.

The plurality of threads 10 of the first knitted layer lA and the plurality of threads 10b of the second knitted layer 1B are knitted with each other.

Specifically, each loop of the plurality of first loops 11b of the first thread of the first knitted layer 1A is disposed through one of the plurality of second loops 12b of the second thread of the second knitted layer 1B, and each loop of the plurality of second loops 12b of the second thread of the first knitted layer 1A is disposed through one of the plurality of first loops 11b of the first thread of the second knitted layer 1B.

Whereby, the knitted textile can be provided with a stable woven configuration with meshes having considerable size, good stretch elasticity and without knotting the threads. Because of non-knotting of the thread, there are much more choices of one or more of the threads such as those of different diameters, elasticity, deformability, colors and/or materials, for weaving the knitted textile, and a required mesh size can be obtained by choosing the thread having different diameter and different length of the extension section. As a result, the knitted textile is aesthetic, stereoscopic and practical.

Although particular embodiments of the invention have been described in detail for purposes of illustration, various modifications and enhancements may be made without departing from the spirit and scope of the invention. Accordingly, the invention is not to be limited except as by the appended claims.

What is claimed is:

1. A knitted textile, comprising:
a first knitted layer, comprising:
a main body, the main body being knitted by a plurality of threads and defining a lateral direction and a longitudinal direction, two ends of the main body along the lateral direction being defined as a first end and a second end, two ends of the main body along the longitudinal direction being defined as an upper end and a lower end, each thread of the plurality of threads extending continuously from the upper end toward the lower end, wherein during extending from the upper end toward the lower end, each thread of the plurality of threads extending toward the first end and toward the second end alternately form a plurality of first loops and a plurality of second loops arranged zigzag, each loop of the plurality of first loops of a first thread of neighboring two of the plurality of threads being disposed through a lower one of the plurality of second loops of a second thread of the neighboring two of the plurality of threads and disposed around an upper one of the plurality of second loops of the second thread, the second thread being next to the first thread, each loop of the plurality of second loops of the second thread being disposed through a lower one of the plurality of first loops of the first thread and disposed around an upper one of the plurality of first loops of the first thread;
wherein each loop of the plurality of first loops of the first thread comprises a first upper section and a first lower section which are connected and crossed, and each loop of the plurality of second loops of the second thread comprises a first extension strip and a second extension strip which are connected and crossed;
wherein the first upper section extends toward the upper end and toward the first end, and is crossed above the first lower section;
wherein the first extension strip extends toward the upper end and toward the second end, and is crossed above the second extension strip;
wherein the first upper section is disposed through the lower one of the plurality of second loops of the second thread, and extends above the first extension strip of the upper one of the plurality of second loops of the second thread;
wherein the first lower section extends under the second extension strip of the upper one of the plurality of second loops of the second thread, extends toward the lower end and toward the second end, and is disposed through the lower one of the plurality of second loops of the second thread;
wherein the first extension strip is disposed through the lower one of the plurality of first loops of the first thread, and extends under the first lower section of the upper one of the plurality of first loops of the first thread; and
wherein the second extension strip extends above the first upper section of the upper one of the plurality of first loops of the first thread, extends toward the lower end and toward the first end, and is disposed through the lower one of the plurality of first loops of the first thread;
a second knitted layer, comprising:
a main body, the main body of the second knitted layer being knitted by a plurality of threads, two ends of the main body of the second knitted layer along the lateral direction being defined as a first end and a second end, two ends of the main body of the second knitted layer along the longitudinal direction being defined as an upper end and a lower end, each thread of the plurality of threads of the second knitted layer extending continuously from the upper end of the main body of the second knitted layer toward the lower end of the main body of the second knitted layer, wherein during extending from the upper end of the main body of the second knitted layer toward the lower end of the main body of the second knitted layer, each thread of the plurality of threads of the main body of the second knitted layer extending toward the first end of the main body of the second knitted layer and toward the second end of the main body of the second knitted layer alternately form a plurality of first loops and a plurality of second loops arranged zigzag, each loop of the plurality of first loops of a first thread of neighboring two of the plurality of threads of the second knitted layer being disposed through a lower one of the plurality of second loops of a second thread of the neighboring two of the plurality of threads of the second knitted layer and disposed around an upper one of the plurality of second loops of the second thread of the second knitted layer, the second thread of the second knitted layer being next to the first thread of the second knitted layer, each loop of the plurality of second loops of the second thread of the second knitted layer being disposed through a lower one of the plurality of first loops of the first thread of the second knitted layer and disposed around an upper one of the plurality of first loops of the first thread of the second knitted layer;
wherein each loop of the plurality of first loops of the first thread of the second knitted layer comprises a first upper section and a first lower section which are connected and crossed, and each loop of the plurality of second loops of the second thread of the second knitted layer comprises a first extension strip and a second extension strip which are connected and crossed;
wherein the first upper section of each loop of the plurality of first loops of the first thread of the second knitted layer extends toward the upper end of the main body of the second knitted layer and toward the first end of the main body of the second knitted layer, and is crossed above the first lower section of each loop of the plurality of first loops of the first thread of the second knitted layer;
wherein the first extension strip of each loop of the plurality of second loops of the second thread of the second knitted layer extends toward the upper end of the main body of the second knitted layer and toward the second end of the main body of the second knitted layer, and is crossed above the second extension strip of each loop of the plurality of second loops of the second thread of the second knitted layer;
wherein the first upper section of each loop of the plurality of first loops of the first thread of the second knitted layer is disposed through the lower one of the plurality of second loops of the second thread of the second knitted layer, and extends above the first extension strip of the upper one of the plurality of second loops of the second thread of the second knitted layer;
wherein the first lower section of each loop of the plurality of first loops of the first thread of the second knitted layer extends under the second extension strip of the upper one of the plurality of second loops of the second thread of the second knitted layer, extends toward the lower end of the main body of the second knitted layer and toward the second end of the main body of the second knitted layer, and is disposed through the lower one of the plurality of second loops of the second thread of the second knitted layer;
wherein the first extension strip of each loop of the plurality of second loops of the second thread of the second knitted layer is disposed through the lower one of the plurality of first loops of the first thread of the second knitted layer, and extends under the first lower section of the upper one of the plurality of first loops of the first thread of the second knitted layer; and
wherein the second extension strip of each loop of the plurality of second loops of the second thread of the second knitted layer extends above the first upper section of the upper one of the plurality of first loops of the first thread of the second knitted layer, extends toward the lower end of the main body of the second knitted layer and toward the first end of the main body of the second knitted layer, and is disposed through the lower one of the plurality of first loops of the first thread of the second knitted layer;
wherein the plurality of threads of the first knitted layer and the plurality of threads of the second knitted layer are knitted with each other.

2. The knitted textile of claim 1, wherein the plurality of the first loops of each of the plurality of threads of the first knitted layer are arranged in line along the lateral direction, and the plurality of the second loops of each of the plurality of threads of the first knitted layer are arranged in line along the lateral direction.

3. The knitted textile of claim 1, wherein each of the plurality of threads of the first knitted layer further includes a plurality of extension sections each connected between one said first loop and one said second loop of the first knitted layer.

4. The knitted textile of claim 3, wherein each of the plurality of extension sections of the first knitted layer is tilted relative to the lateral direction at an angle of 45 degrees.

5. The knitted textile of claim 3, wherein in the lateral direction, extents of each of the plurality of extension sections of the first knitted layer, each of the plurality of first loops of the first knitted layer and each of the plurality of second loops of the first knitted layer are substantially the same.

6. The knitted textile of claim 3, wherein in the longitudinal direction, extents of each of the plurality of extension sections of the first knitted layer, each of the plurality of first loops of the first knitted layer and each of the plurality of second loops of the first knitted layer are substantially the same.

7. The knitted textile of claim 1, wherein each of the plurality of threads of the first knitted layer is a multifilament thread.

8. The knitted textile of claim 4, wherein in the lateral direction, extents of each of the plurality of extension sections of the first knitted layer, each of the plurality of first loops of the first knitted layer and each of the plurality of second loops of the first knitted layer are substantially the same; in the longitudinal direction, extents of each of the plurality of extension sections of the first knitted layer, each of the plurality of first loops of the first knitted layer and each of the plurality of second loops of the first knitted layer are substantially the same; the plurality of threads of the first knitted layer further define a plurality of meshes each being substantially diamond; each of the plurality of first loops of the first knitted layer is configured by one of the plurality of threads of the first knitted layer first extending toward the upper end of the first knitted layer and toward the first end of the first knitted layer and then bending to extend toward the lower end of the first knitted layer and toward the second end of the first knitted layer, and each of the plurality of second loops of the first knitted layer is configured by one of the plurality of threads of the first knitted layer first extending toward the upper end of the first knitted layer and toward the second end of the first knitted layer and then bending to extend toward the lower end of the first knitted layer and toward the first end of the first knitted layer; the plurality of the first loops of each of the plurality of threads of the first knitted layer are arranged in line along the lateral direction, and the plurality of the second loops of each of the plurality of threads of the first knitted layer are arranged in line along the lateral direction; each of the plurality of threads of the first knitted layer is a multifilament thread; two halves of each of the plurality of first loops of the first knitted layer cross and interlace with each other within one second loop of the plurality of the second loops of the first knitted layer, and two halves of each of the plurality of second loops of the first knitted layer cross and interlace with each other within one first loop of the plurality of the first loops of the first knitted layer.

9. The knitted textile of claim 8, wherein one of the two halves of each of the plurality of first loops of the first knitted layer which bends to extend toward the lower end of the first knitted layer and toward the second end of the first knitted layer is located between the other of the two halves of each of the plurality of first loops of the first knitted layer and an upper portion of one second loop of the plurality of the second loops of the first knitted layer; and one of the two halves of each of the plurality of second loops of the first knitted layer which bends to extend toward the lower end of the first knitted layer and toward the first end of the first knitted layer is located between the other of the two halves of each of the plurality of second loops of the first knitted layer and a lower portion of one first loop of the plurality of the first loops of the first knitted layer.

10. The knitted textile of claim 1, wherein each loop of the plurality of first loops of the first thread of the first knitted layer is disposed through one of the plurality of second loops of the second thread of the second knitted layer, and each loop of the plurality of second loops of the second thread of the first knitted layer is disposed through one of the plurality of first loops of the first thread of the second knitted layer.
